(19) United States
(12) Patent Application Publication
(10) Pub. No.: US 2007/0247669 A1
(43) Pub. Date: Oct. 25, 2007

(54) Fax server, method for managing fax servers, and computer program product

(75) Inventors: Hidetaka Iwai, Amagasaki-shi (JP); Yoshiyuki Tamai, Itami-shi (JP); Kazumi Sawayanagi, Itami-shi (JP); Takeshi Minami, Amagasaki-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Tokyo (JP)

(21) Appl. No.: 11/500,911

(22) Filed: Aug. 9, 2006

(30) Foreign Application Priority Data
Apr. 25, 2006 (JP) 2006-121061

(51) Int. Cl. H04N 1/00

(52) U.S. Cl. 358/400

(57) ABSTRACT

An image forming device having a function to provide a fax server service based on requests from clients in a segment is provided with a high function server detection portion for detecting a high function fax server having a higher communication function than the image forming device itself and having a function to provide the fax server service, a server shift necessity judgment portion for judging whether or not to shift a role to provide the fax server service to the clients from the image forming device to the detected high function fax server, and a server shift processing portion for performing a shift process for shifting the role from the image forming device to the high function fax server, if it is judged that shifting is to be performed.

This application is based on Japanese patent application No. 2006-121061 filed on Apr. 25, 2006, the contents of which are hereby incorporated by reference.

### BACKGROUND OF THE INVENTION

1. Field of the Invention

The present invention relates to a device such as an MFP having the function of a fax server, and a method for managing fax servers inside a network.

2. Description of the Related Art

Conventionally, a fax server has been used in a network within a limited range, such as a LAN. A fax server transmits data that has been received from clients inside the network to destination fax devices via telephone lines for example, using a protocol such as G3, or allocates fax data that has been transmitted from fax devices to clients inside the network. In other words, a fax server centrally provides a service to transmit and receive fax data in the network.

In recent years, the function of a fax server has come to be provided also in image forming devices called multifunction devices or MFPs (multi function peripherals) and personal computers having fax voice modems, for example. Accordingly, a plurality of devices that can provide services of fax servers may be present in a network.

Furthermore, in recent years, fax communications have been proposed in which fax data can be transmitted via an Internet Protocol (IP) network by applying VoIP telephone technology. These fax communications are sometimes called a “Session Initiation Protocol (SIP)-fax” or an “Internet Protocol (IP)-fax”.

Herein, as a method for transmitting and receiving fax data, methods as described in Japanese unexamined patent publication Nos. 2004-172898, 2002-33870, 2003-309710, and 2002-223257 have been proposed.

According to a method described in Japanese unexamined patent publication No. 2004-172898, provided are a plurality of fax devices that have predetermined image processing ability corresponding to image processing systems and that can be connected to an existing public communication network, and a communication means for connecting these fax devices into one group. When fax image data taking a fax device as the destination is received, the fax device judges whether or not, among the plurality of fax devices connected into one group in advance, there is a fax device having the image processing ability corresponding to the image processing system of the fax image data from the correspondent, and based on results of the judgment, makes a request to form an image, or forms an image based on fax image data after predetermined image processing.

According to a method described in Japanese unexamined patent publication No. 2002-33870, in a system in which an image forming device (operating unit) that is operated by a user is connected via a network to another image forming device (connection unit), if the operating unit has a fax function, then a list of internal set values is not printed out but transmitted via fax to a predetermined terminal as data without any processing. If the operating unit does not have a fax function, and the connection unit has a fax function, then data of a list of internal set values is transmitted to the connection unit, and instead of the operating unit, the connection unit is led to transmit via fax the list of internal set values of the operating unit. If there is no connection unit having a fax function in the network, then a message is displayed indicating that it is impossible to perform fax transmission.

According to a method described in Japanese unexamined patent publication No. 2003-309710, in a transmission control device, a CPU refers to receiving ability that has been acquired from a correspondent fax, and converts data that is to be transmitted via fax into data in an appropriate format. Furthermore, the CPU refers to fax transmission history information of the past, selects a transmission method (modem control command and communication speed) in which the number of successes occupies a large proportion in the number of transmissions, and transmits data via fax with this transmission method using a fax modem device. Furthermore, if it is necessary to retransmit data due to communication errors, the CPU retries with various transmission methods depending on the number of retransmission.

According to a method described in Japanese unexamined patent publication No. 2002-223257, a first iFAX is connected via the Internet to a second iFAX, a third iFAX, and a client PC. It is possible to perform fax communications between the first iFAX, the second iFAX, and the third iFAX, following the communication procedure of T.37, which is a communication protocol using e-mail and SMTP. Furthermore, it is possible to transmit and receive data via ordinary e-mail. The transmitter and the receiver exchange communication ability via e-mail, the communication procedure of the highest function that is provided in both the transmitter and the receiver is selected, and communications are performed via fax.

As described above, a plurality of devices that are provided with the function of fax servers may be present in a network. Furthermore, a new device may be added to the network, or the function of a fax server may be added to an existing device due to hardware or software expansion.

In this case, it is convenient for a client to let a device having a high communication function among these devices play a role as a fax server in the network, but this is impossible according to conventional methods. Accordingly, it is necessary for an administrator to investigate the performance of the devices in the network and perform settings.

### SUMMARY OF THE INVENTION

In view of the foregoing problems, there is a need to make it easy to let a device having a higher communication function in a network such as a LAN play a role of a fax server in the network.

A fax server according to one aspect of the present invention is a fax server having a function to provide a service of fax communications based on a request from a client. The fax server includes a detection portion for detecting a second fax server having a higher communication function than the fax server and having a function to provide the service, a shift appropriateness judgment portion for judging whether it is necessary to shift a role to provide the service to the client from the fax server to the second fax server detected by the detection portion, and a shift processing portion for performing a shift process for shifting the role from the fax server to the second fax server if the shift appropriateness judgment portion judges that shifting is to be performed.

Preferably, in a case where the detection portion detects a Session Initiation Protocol (SIP)-fax function as the communication function, if any correspondent device that can be a correspondent device in fax communications has a Session Initiation Protocol (SIP)-fax function, then the shift appropriateness judgment portion judges that the role is to be shifted.

Further, the fax server includes a fax number data storage portion for storing fax number data indicating a fax number for each correspondent device, wherein the shift processing portion performs the shift process by creating second telephone number data indicating an Internet protocol (IP) address or a fax number of the correspondent device having the SIP-fax function based on the fax number data, and transmitting the second telephone number data to the second fax server.

Further, the shift processing portion acquires the IP address or the fax number by making an inquiry to a Session Initiation Protocol (SIP) server.

These and other characteristics and objects of the present invention will become more apparent by the following descriptions of preferred embodiments with reference to drawings.

### BRIEF DESCRIPTION OF THE DRAWINGS

FIG. 1 is a diagram showing an example of an overall configuration of an intranet.

FIG. 2 is a diagram showing an example of a hardware configuration of an image forming device.

FIG. 3 is a diagram showing an example of a functional configuration of the image forming device.

FIG. 4 is a diagram showing an example of an address book database.

FIG. 5 is a diagram showing an example of an in-branch address book database.

FIG. 6 is a diagram showing an example of a hardware configuration of a Session Initiation Protocol (SIP) server.

FIG. 7 is a diagram showing an example of a communication history table.

FIG. 8 is a flowchart illustrating an example of the flow of a communication correspondent function inquiry process.

FIG. 9 is a flowchart illustrating an example of the flow of a shift appropriateness judgment process.

FIG. 10 is a diagram showing an example of a server shift recommendation screen.

FIG. 11 is a flowchart illustrating an example of the flow of a server shift process.

FIG. 12 is a diagram showing an example of an address book database.

FIG. 13 is a diagram showing an example of an overall configuration of the intranet to which an image forming device has been newly added.

FIG. 14 is a flowchart illustrating an example of the flow of an overall process of the image forming device.

### DESCRIPTION OF THE PREFERRED EMBODIMENTS

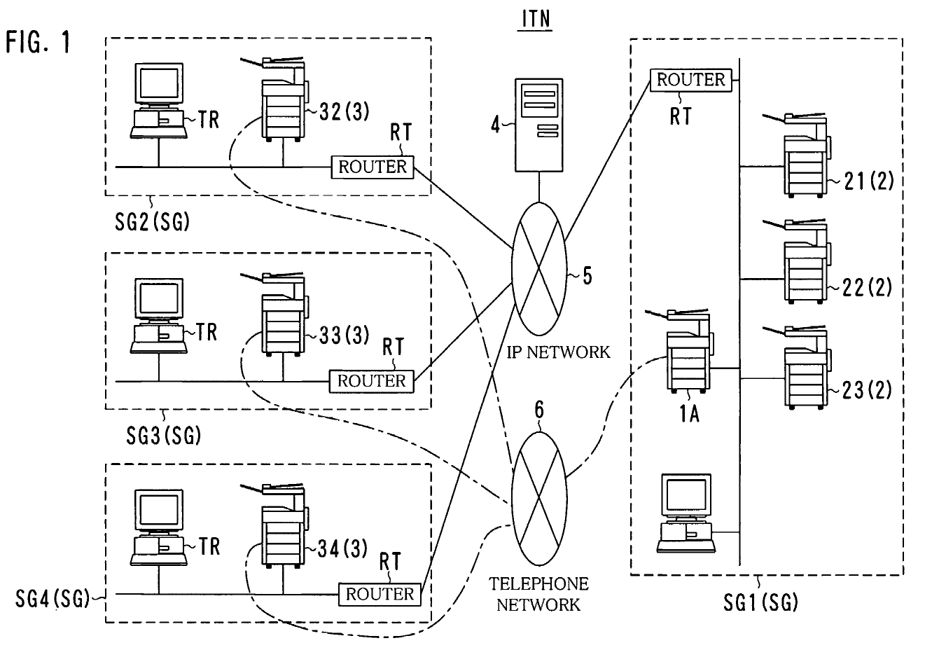

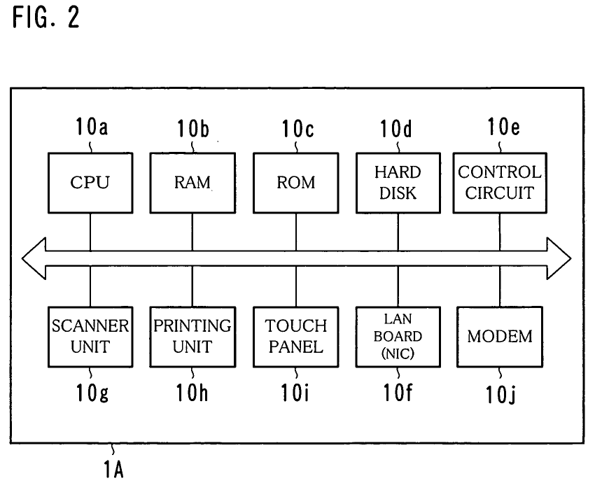

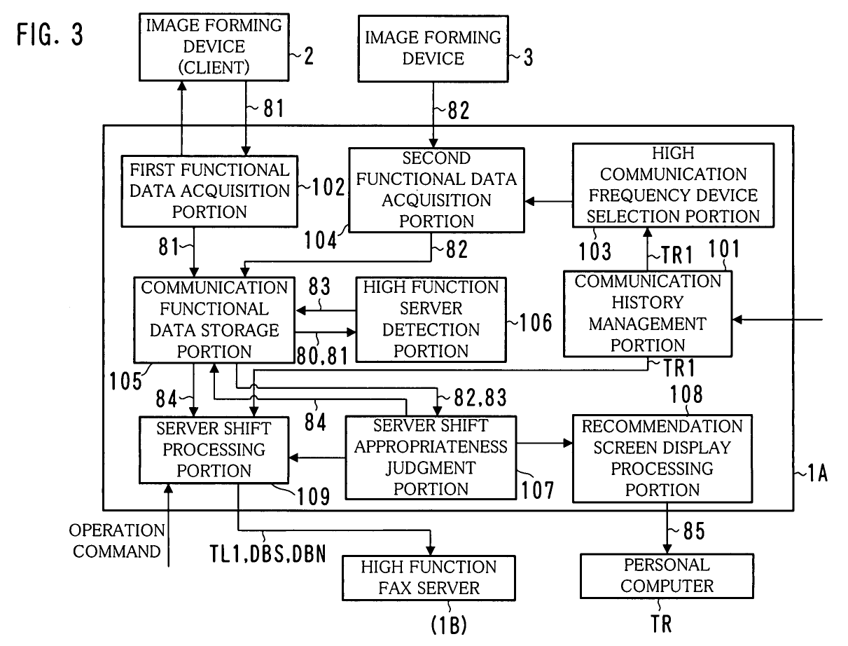

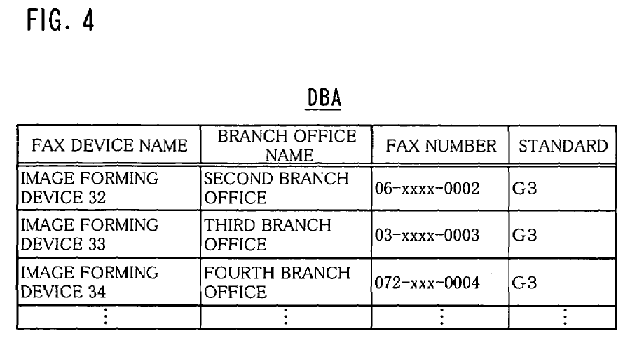

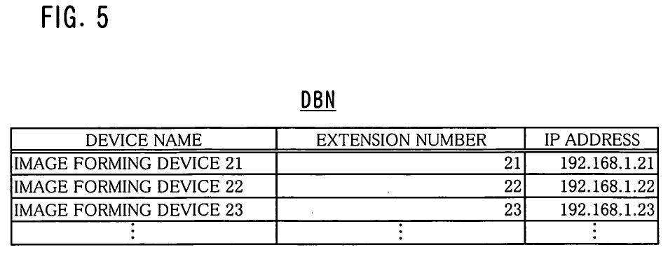

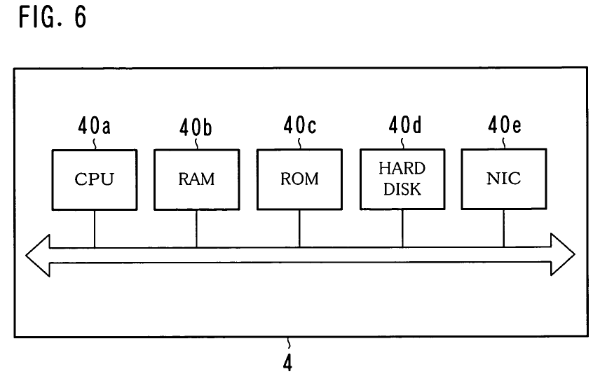

FIG. 1 is a diagram showing an example of an overall configuration of an intranet ITN, FIG. 2 is a diagram showing an example of a hardware configuration of an image forming device 1A, FIG. 3 is a diagram showing an example of a functional configuration of the image forming device 1A, FIG. 4 is a diagram showing an example of an address book database DBA, FIG. 5 is a diagram showing an example of an in-branch address book database DBN, and FIG. 6 is a diagram showing an example of a hardware configuration of a Session Initiation Protocol (SIP) server 4.

As shown in FIG. 1, the intranet ITN includes a plurality of segments SG, the SIP server 4, and an Internet Protocol (IP) network 5, for example. This intranet ITN is constructed in an organization such as a company having a plurality of bases that are away from each other. Hereinafter, a description is made taking as an example the intranet ITN that is constructed in a company X having four branch offices, namely a first branch office to a fourth branch office.

The segments SG are LANs (local area networks) that are respectively provided in the branch offices. Hereinafter, the segments SG of the first branch office to the fourth branch office may be respectively referred to as a “segment SG1” to a “segment SG4” by way of distinguishing them from each other.

The segment SG1 includes the image forming device 1A, image forming devices 2, a personal computer TR, and a router RT, for example. These devices can be connected to each other via a LAN cable or a wireless link.

The segment SG2 includes an image forming device 3, a personal computer TR, and a router RT, for example. These devices can be connected to each other via a LAN cable or a wireless link. The segment SG3 and the segment SG4 have a configuration similar to that of the segment SG2. Hereinafter, the image forming devices 3 of the segments SG2 to SG4 may be respectively referred to as an “image forming device 32” to an “image forming device 34” by way of distinguishing them from each other.

The router RT that is provided in each segment SG can be connected via the IP network 5 to the routers RT of the other segments SG. Accordingly, the devices of the segments SG can communicate with each other.

The image forming device 1A, the image forming devices 2, and the image forming devices 3 are processing devices in which various functions such as a copy function, a scanner function, and a network printing function are integrated. In general, the devices are sometimes called multifunction devices or MFPs (multi function peripherals), for example.

The “network printing function” is a function to print an image on paper by receiving image data from a personal computer or other devices. This function is sometimes called a “network printer function” or a “PC print function”, for example.

Furthermore, the image forming device 1A of the segment SG1 is provided with a function to transmit and receive fax data with the G3 standard (hereinafter, referred to as a “G3 fax function”), and a function of a fax server (hereinafter, referred to as a “fax server function”). According to these functions, image data that has been received from the image forming devices 2 in the segment SG1 can be transmitted as fax data by the image forming device 1A via a telephone network 6 to a fax device that is specified by a user. For example, if a fax number of the second branch office is specified by the user, then fax data is transmitted to the image forming device 32 by dialing the fax number, thereby establishing a connection to the image forming device 32. Furthermore, fax data that has been transmitted via the telephone network 6 from other fax devices is allocated to the image forming devices 2 taken as the destinations. It should be noted that the fax number is a fax number in the telephone network 6. If the telephone network 6 is a public telephone network, then the fax number is an external number. If the telephone network 6 is an extension telephone network, then the fax number is a so-called extension number.

As shown in FIG. 2, the image forming device 1A includes a CPU 10a, a RAM 10b, a ROM 10c, a hard disk 10d, a control circuit 10e, a LAN board 10f, a scanner unit 10g, a printing unit 10h, a touch panel 10i, and a modem 10j, for example.

The control circuit 10e is a circuit for controlling the hard disk 10d, the LAN board 10f, the scanner unit 10g, the printing unit 10h, the touch panel 10i, and the modem 10j, for example.

The LAN board 10f is an NIC (network interface card) for performing data communications (so-called Internet Protocol (IP) communications) based on TCP/IP with the image forming devices 2 or the personal computer TR belonging to the segment SG1, and is used also for performing Internet Protocol (IP) communications via the routers RT and the IP network 5 with devices of the other segments SG.

The touch panel 10i displays a screen for providing messages or instructions to the user, a screen for the user to enter desired types of processing and processing conditions, and a screen indicating results of processes performed by the CPU 10a, for example. The user can give commands to the image forming device 1A or specify processing conditions by touching predetermined positions on the touch panel 10i.

The scanner unit 10g optically captures a document image expressed by text, numerical formulas, symbols, photographs, diagrams, illustrations and the like that are depicted on paper, and creates image data.

The printing unit 10h forms an image based on image data obtained with the scanner unit 10g or image data transmitted from the personal computer TR or other devices, and prints the image on paper.

Programs such as a program for the G3 fax function, a program for the fax server function, and a program for a document server function are installed on the ROM 10c or the hard disk 10d. The program for the fax server function includes a module for managing an address book database in which address data is written that indicates a device name, a fax number, a supportable communication standard and other information of each of the fax devices (such as the image forming devices 32 to 34). With this module, the image forming device 1A is provided with an address book database DBA, as shown in FIG. 4, indicating a telephone number and other information of each of the fax devices outside the segment SG1. Furthermore, an in-branch address book database DBN, as shown in FIG. 5, indicating an extension number, an Internet Protocol (IP) address and other information of each of the image forming devices 2 inside the segment SG1 is provided.

The “document server function” is a function to provide each user with a storage area called, for example, a “box” or a “personal box” corresponding to a folder or directory in a personal computer, thereby enabling the user to store document data such as an image file in the user's own storage area. This function is sometimes called a “box function”.

Furthermore, programs and data for implementing portions such as a communication history management portion 101, a first functional data acquisition portion 102, a high communication frequency device selection portion 103, a second functional data acquisition portion 104, a communication functional data storage portion 105, a high function server detection portion 106, a server shift appropriateness judgment portion 107, a recommendation screen display processing portion 108, and a server shift processing portion 109 as shown in FIG. 3 are stored on the hard disk 10d. When a new image forming device having a fax server function is added into the segment SG1 also including the image forming device 1A, if necessary, the communication history management portion 101 to the server shift processing portion 109 performs a process for shifting (changing, replacing) an image processing device playing a role of a fax server in the segment SG1. Processing details of each portion are described later one by one. It should be noted that in FIG. 1, the image forming device 1A plays the role of the fax server in the segment SG1.

These programs and data are read out to the RAM 10b when necessary, and the CPU 10a executes the programs. A part of or all the functions shown in FIG. 3 may be implemented with the control circuit 10e.

Referring back to FIG. 1, the image forming devices 2 have the function of clients of a fax server (hereinafter, referred to as a “fax client function”). With this function, the image forming devices 2 play a role as clients of the image forming device 1A, and can be clients of a high function fax server described later. Hereinafter, the image forming devices 2 may be respectively referred to as an “image forming device 21”, an “image forming device 22”, . . . by way of distinguishing them from each other.

The image forming devices 32 to 34 have the G3 fax function. Furthermore, the image forming device 32 has a function to establish a session with a communication correspondent using a SIP (Session Initiation Protocol), and to transmit and receive fax data via the IP network. Hereinafter, this function is referred to as a “Session Initiation Protocol (SIP)-fax function”.

The hardware configurations of the image forming devices 2 and the image forming devices 3 are basically similar to the hardware configuration of the image forming device 1A shown in FIG. 2. It should be noted that a modem is not necessary in the image forming devices 2. Furthermore, a program for the fax client function is installed on the hard disks of the image forming devices 2. A program for the G3 fax function is installed on the hard disks of the image forming devices 32 to 34. Furthermore, a program for the SIP-fax function is also installed on the hard disk of the image forming device 32.

As shown in FIG. 6, the SIP server 4 includes a CPU 40a, a RAM 40b, a ROM 40c, a hard disk 40d, and a NIC 40e, for example. Various programs such as a program (telephone number-address conversion program) for acquiring a fax number in the IP network 5 of a fax device having the SIP-fax function in the intranet ITN, that is, an Internet Protocol (IP) address or mail address corresponding to a fax number for IP telephone, and communicating it to another fax device having the same SIP-fax function, and a program for controlling a session between fax devices that transmit fax data via the IP network 5 are installed on the hard disk 40d. With this function of the SIP server 4, the image forming device 32 having the SIP-fax function can perform fax communications using a Session Initiation Protocol (SIP) via the IP network 5 by taking as a correspondent another fax device having the SIP-fax function. It should be noted that since in FIG. 1, there is no other such fax device in the intranet ITN, if the communication correspondent is the image forming device 1A, or the image forming device 33 or 34, then fax communications are performed via the telephone network 6 based on the G3 fax function.

Herein, a staff member (user) working for the first branch office can transmit fax data to the image forming device 3 of another branch office by operating any one of the image forming devices 2 provided in the segment SG1 in a conventional manner as described below. Document paper is placed on a document platen of the image forming device 2, and a key (one-touch key) corresponding to the correspondent in the address book that is displayed on the touch panel 10i is pressed. Next, a start key is pressed. Then, the image forming device 2 captures an image depicted on a face of the document paper that has been placed, and gives a request to perform a transmission process of fax data, by transferring the obtained image data to the image forming device 1A. The image forming device 1A dials the fax number corresponding to the key that has been pressed by the user, and starts a process in which the image data transferred from the image forming device 2 is converted into fax data in a format corresponding to a G3 fax. After a session with the correspondent has been established, the fax data is transmitted to the correspondent.

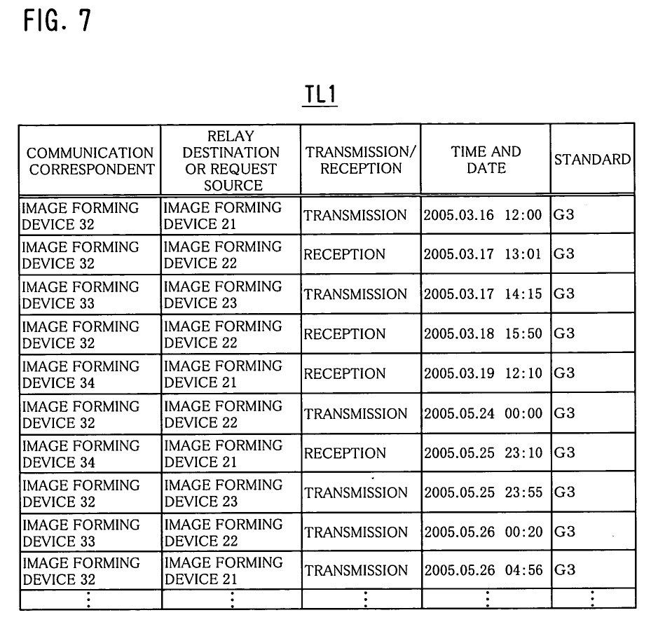

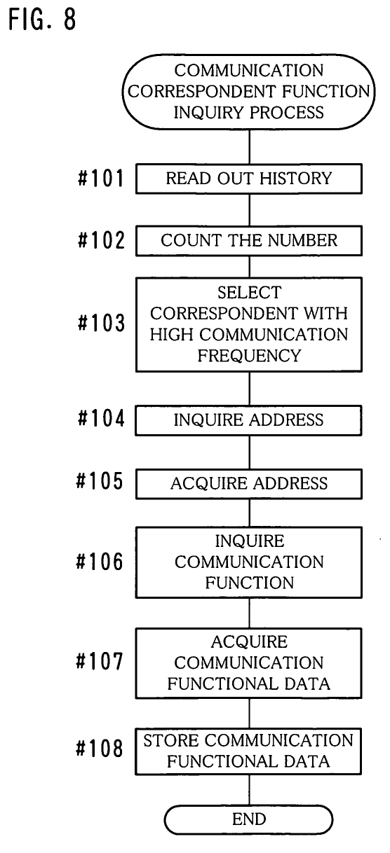

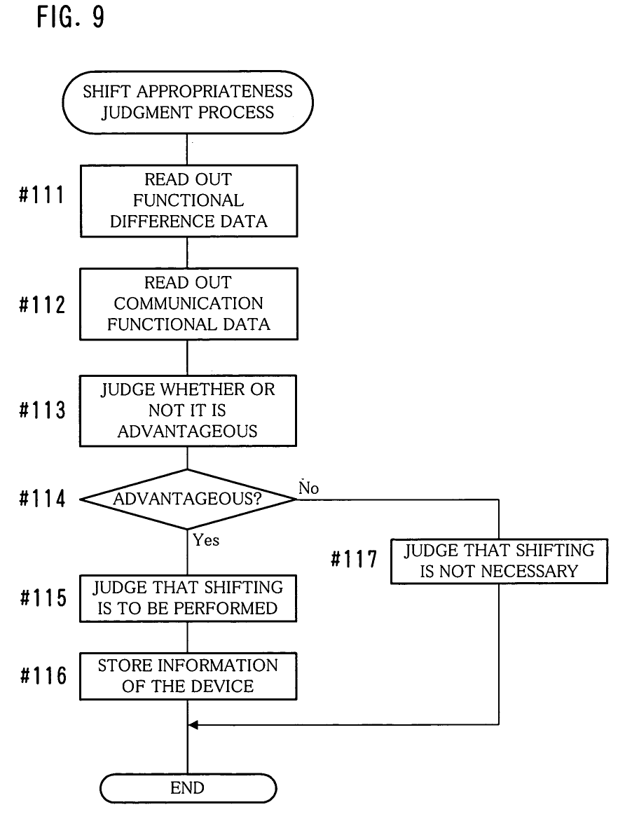

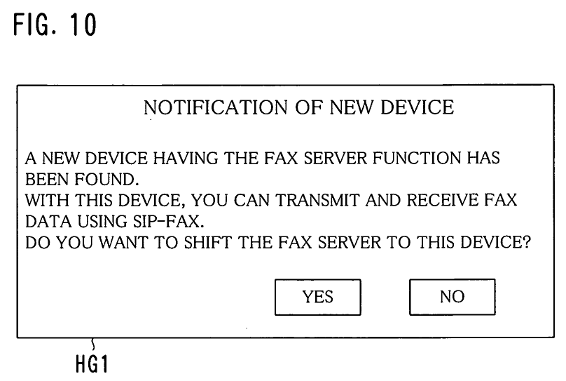

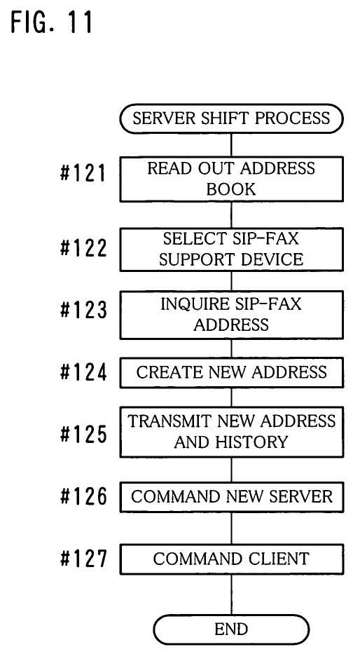

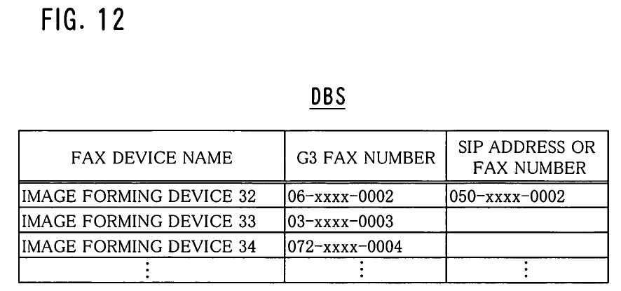

FIG. 7 is a diagram showing an example of a communication history table TL1, FIG. 8 is a flowchart illustrating an example of the flow of a communication correspondent function inquiry process, FIG. 9 is a flowchart illustrating an example of the flow of a shift appropriateness judgment process, FIG. 10 is a diagram showing an example of a server shift recommendation screen HG1, FIG. 11 is a flowchart illustrating an example of the flow of a server shift process, and FIG. 12 is a diagram showing an example of an address book database DBS.

Next, processing details of each portion in the image forming device 1A shown in FIG. 3 when operating as the fax server of the segment SG1 are described.

The communication history management portion 101 has the communication history table TL1, as shown in FIG. 7, for accumulating data indicating the history of fax communications that have been performed in the past by the image forming device 1A itself. Each time the image forming device 1A itself performs fax communications, a record indicating the communication contents is written into the communication history table TL1.

The first functional data acquisition portion 102 performs a process for acquiring communication functional data 81 indicating information with respect to communication functions of the other devices in the segment SG to which the image forming device 1A belongs, that is, the segment SG1. This process can be performed in the following method, for example.

The first functional data acquisition portion 102 transmits commands to respond with communication functions to all devices (nodes) in the segment SG1. More specifically, a broadcast is performed. Then, based on the commands, the devices transmit the communication functional data 81 with respect to their own communication functions to the image forming device 1A. The first functional data acquisition portion 102 stores the transmitted communication functional data 81 in the communication functional data storage portion 105 in association with identifying information (such as Internet Protocol (IP) address or device name) of devices that are the transmission sources.

In addition to the communication functional data 81, communication functional data 82, functional difference data 83, and advantageous device data 84 described later, for example, are stored in the communication functional data storage portion 105. Furthermore, communication functional data 80 with respect to communication functions of the image forming device 1A itself is also stored.

The high communication frequency device selection portion 103 selects, from among the fax devices belonging to the segments SG other than the segment SG1, that is, the image forming devices 3, the image forming devices 3 having high frequency of fax communications performed with the image forming device 1A.

The second functional data acquisition portion 104 performs a process for requesting and acquiring the communication functional data 82 indicating information of the communication functions with respect to each of the image forming devices 3 that have been selected by the high communication frequency device selection portion 103. Herein, the flow of processes performed by the high communication frequency device selection portion 103 and the second functional data acquisition portion 104 is described with reference to the flowchart in FIG. 8.

The high communication frequency device selection portion 103 reads out (#101) the communication history table TL1 from the communication history management portion 101, and based on the communication history table TL1, counts (#102) for each communication correspondent the number of fax communication performed in a predetermined period of the past (such as the past one year or a period from the start of operation of the image forming device 1A to the present). More specifically, the frequency of fax communications is obtained. Then, communication correspondents having the number of operations that is equal to or larger than a predetermined value are selected (#103). Hereinafter, communication correspondents selected by the high communication frequency device selection portion 103 are referred to as “high communication frequency devices”.

The second functional data acquisition portion 104 makes an inquiry (#104) to the SIP server 4 with respect to an e-mail address of each of the high communication frequency devices selected by the high communication frequency device selection portion 103. For example, if the image forming device 32 and the image forming device 33 are selected as high communication frequency devices, then an inquiry is made with respect to an e-mail address of each of these two devices. At that time, the second functional data acquisition portion 104 shows the SIP server 4 identifying information (such as fax number or device name) of the high communication frequency devices. Then, the SIP server 4 responds to the image forming device 1A with e-mail addresses corresponding to the shown identifying information.

When the response of e-mail addresses is acquired (#105), the second functional data acquisition portion 104 transmits (#106) via e-mail commands to respond with communication functions to the e-mail addresses. Then, based on the commands, the devices transmit (respond with) the communication functional data 82 with respect to their own communication functions to the image forming device 1A via e-mail.

When the communication functional data 82 is received (#107), the second functional data acquisition portion 104 stores (#108) the data in the communication functional data storage portion 105 in association with identifying information (such as Internet Protocol (IP) address, device name, e-mail address, or fax number) of the fax devices that are the transmission sources.

Referring back to FIG. 3, the high function server detection portion 106 detects a device having a communication function superior to a communication function of the image forming device 1A itself and having a fax server function, by comparing the communication functions indicated by the communication functional data 81 of each device stored in the communication functional data storage portion 105 and the communication functions of the image forming device 1A itself. Hereinafter, the device detected by the high function server detection portion 106 is referred to as a “high function fax server”. Then, the functional difference data 83 indicating results of the comparison between the communication functions of the image forming device 1A and the communication functions of the high function fax server is stored in the communication functional data storage portion 105.

The server shift appropriateness judgment portion 107 performs a process in which it is judged whether or not to shift the role of the fax server of the segment SG1 to the high function fax server detected by the high function server detection portion 106. This process can be performed following the procedure as shown in FIG. 9, for example.

The server shift appropriateness judgment portion 107 reads out (#111) the functional difference data 83 of the high function fax server detected by the high function server detection portion 106, and reads out (#112) the communication functional data 82 of each of the fax devices of the other segments SG, that is, the image forming devices 3.

It is judged (#113) which device is a correspondent (the image forming device 3) with which fax communications can be performed more advantageously than before when a part of or all communication functions indicated by the functional difference data 83 are applied, by comparing the functional difference data 83 and the communication functional data 82 and confirming communication functions (communication functions as the so-called greatest common measure) indicated by both.

For example, if the functional difference data 83 indicates the SIP-fax function, and the communication functional data 82 of the image forming device 32 also indicates the SIP-fax function, then it is judged that fax communications can be performed more advantageously than before, taking the image forming device 32 as a correspondent, because the high function fax server and the image forming device 32 can perform fax communications using a Session Initiation Protocol (SIP) and the communication environment is improved.

If one or a plurality of such image forming devices 3 are found (#114: Yes), then it is judged (#115) that the role of the fax server of the segment SG1 is to be shifted from the image forming device 1A to the high function fax servers. Then, the advantageous device data 84 indicating the identifying information of the image forming devices 3 is stored in the communication functional data storage portion 105 (#116).

On the other hand, if no such image forming device 3 is found (#114: No), then it is judged (#117) that shifting of the role of the fax server is not necessary.

Referring back to FIG. 3, if it is judged by the server shift appropriateness judgment portion 107 that the role of the fax server is to be shifted to (changed so as to be performed by) the high function fax server, then the recommendation screen display processing portion 108 recommends shifting by transmitting screen data 85 for displaying the server shift recommendation screen HG1 as shown in FIG. 10 to an e-mail address of an administrator (such as a system administrator of the first branch office) of the segment SG1.

The administrator lets his/her own terminal device (such as the personal computer TR in the segment SG1) receive the screen data 85 and display the server shift recommendation screen HG1. Then, if the administrator accepts the role of the fax server to be shifted from the image forming device 1A to the high function fax server, then a “YES” key is clicked. Accordingly, the terminal device of the administrator transmits a command to perform a shift process to the image forming device 1A.

When the command to perform a shift process is received, the server shift processing portion 109 performs a process for shifting the role of the fax server to the high function fax server detected by the high function server detection portion 106. The processing details differ depending on the communication functions (that is, communication functions superior to communication functions of the image forming device 1A, among the communication functions of the high function fax server) indicated by the functional difference data 83 of the high function fax server. For example, if a communication function indicated by the functional difference data 83 is the SIP-fax function, then the shift process is performed following the procedure as shown in FIG. 11.

The server shift processing portion 109 reads out (#121) the address book database DBA in FIG. 4 to the RAM 10b. Among members (fax devices) described on the address book database DBA, an address of a fax device having the SIP-fax function is selected (#122) based on the communication functional data 81, and an inquiry is made (#123) to the SIP server 4 with respect to a Session Initiation Protocol (SIP)-fax address or fax number of the fax device. For example, among the three image forming devices 32 to 34 shown in FIG. 4, only the image forming device 32 has the SIP-fax function as described above, and thus an inquiry is made with respect to the image forming device 32. Alternatively, an inquiry may be made directly to the image forming device 32 using e-mail, for example.

The address book database DBS of the address book that supports Session Initiation Protocol (SIP)-fax as shown in FIG. 12 is created (#124) by reflecting results of the inquiry on the address book database DBA that has been read out.

To the high function fax server, the communication history table TL1 and the in-branch address book database DBN are transmitted together with the created address book database DBS (#125), and a command to start the process as the fax server of the segment SG1 thereafter is given (#126). Furthermore, a command to change settings so as to regard the high function fax server as the fax server thereafter is given to the devices having the fax client function inside the segment SG1, that is, the image forming devices 2 (#127).

Accordingly, the high function fax server stores the communication history table TL1, the address book database DBS, and the in-branch address book database DBN in a predetermined storage portion and starts to provide a service as the fax server of the segment SG1. On the other hand, the image forming devices 2 come to be used by the user as clients of the high function fax server. More specifically, fax communications between the image forming devices 2 and a fax device outside the segment SG1 come to be performed via the high function fax server.

The user can perform an operation as before without considering the change of the device serving as the fax server. More specifically, the user requesting to transmit fax data places document paper on the document platen, selects a fax device name of the transmission destination by pressing one of one-touch keys that are displayed on the touch panel of the image forming device 2, and then presses a start key. Although a request to transmit fax data had been made by the image forming device 2 to the image forming device 1A, after the role shift, the request is made to the high function fax server. The high function fax server transmits the fax data based on the request from the image forming device 2. For example, in a case where the high function fax server is characterized by being provided with the SIP-fax function, if the transmission destination selected by the user is provided with the SIP-fax function, then the high function fax server transmits the fax data by establishing a session with a fax device that is the transmission destination based on a Session Initiation Protocol (SIP) address or telephone number (such as Internet Protocol (IP) telephone number in a “0A0” format) displayed on the address book database DBS, and if the transmission destination is not provided with the SIP-fax function, then the high function fax server transmits the fax data by establishing a session with a fax device that is the transmission destination based on a G3 fax number.

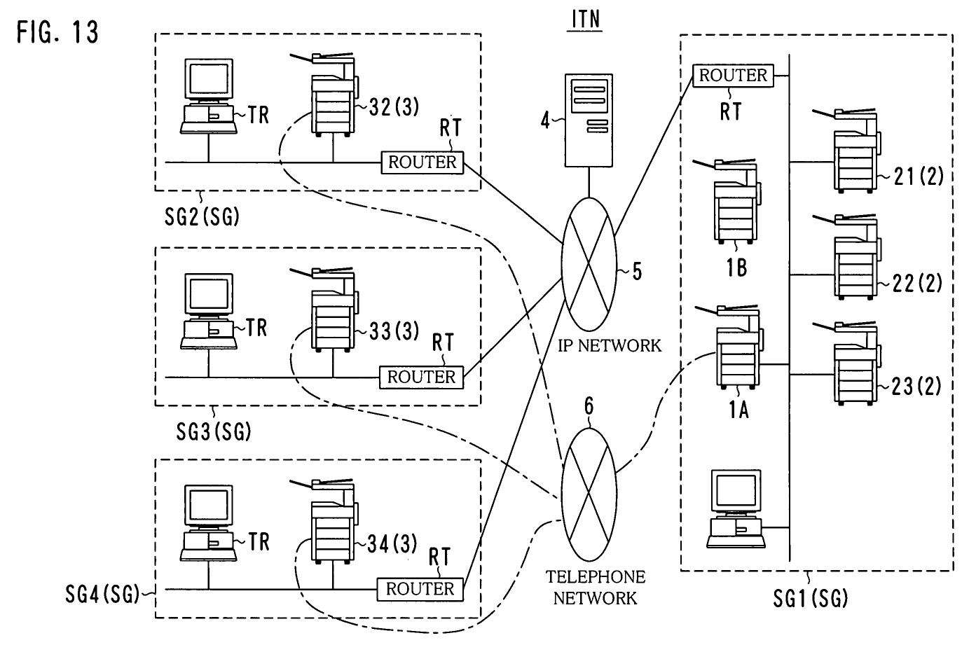

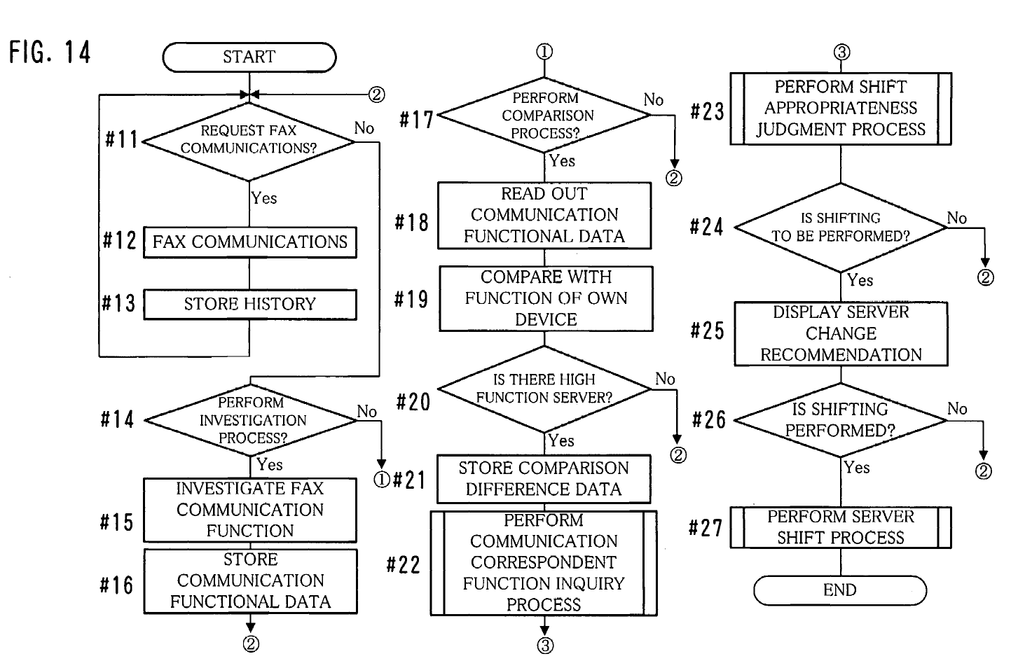

FIG. 13 is a diagram showing an example of an overall configuration of the intranet ITN to which an image forming device 1B has been newly added, and FIG. 14 is a flowchart illustrating an example of the flow of an overall process of the image forming device 1A.

Next, the flow of a process performed by the image forming device 1A is described with reference to the flowchart in FIG. 14, taking as an example a case in which the image forming device 1B having the fax server function, the G3 fax function, and the SIP-fax function has newly joined the segment SG1 as shown in FIG. 13.

If a request to perform fax communications is made (#11: Yes), then the image forming device 1A performs (#12) a process of G3 fax communications as a fax server of the segment SG1 as before. More specifically, if a request to transmit fax data to a fax device outside the segment SG1 is received from the image forming device 2, then the destination specified by the image forming devices 2 is dialed and the fax data is transmitted. Alternatively, fax data from a fax device outside the segment SG1 is allocated to the image forming devices 2 based on the in-branch address book database DBN (see FIG. 5). Each time such fax communications are performed, a record indicating the communication contents is stored in the communication history table TL1 (#13).

While the power source is on, the image forming device 1A performs as appropriate the processes in Steps #12 and #13 each time a request to perform fax communications is made. Furthermore, while the power source is on, on a regular basis, the communication functional data 81 of the other devices belonging to the segment SG1 is collected, that is, communication functions of the other devices are investigated (#15), and the communication functional data 81 is stored in a predetermined storage portion (#16). It should be noted that if the communication functional data 81 of the same device has been already stored, then the older communication functional data 81 is deleted and the newer communication functional data 81 is stored. Furthermore, on a regular basis, the collected communication functional data 81 is read out (#18), and an attempt is made (#19) to detect a device having a communication function superior to a communication function of the image forming device 1A itself and having a fax server function, that is, a high function fax server, by comparing the communication functions indicated by the communication functional data 81 and the communication functions of the image forming device 1A itself.

If a high function fax server is detected (#20: Yes), then the functional difference data 83 indicating the difference between the communication functions of the image forming device 1A itself and the communication functions of the high function fax server is stored in a predetermined storage portion (#21). In this embodiment, as shown in FIG. 13, it is assumed that the image forming device 1B that has newly joined the segment SG1 is detected as a high function fax server. Thus, the functional difference data 83 of the image forming device 1B is acquired.

Based on the communication history table TL1, a process is performed (#22) in which an inquiry is made with respect to communication functions of correspondents with which fax communications are frequently performed at ordinary times, that is, high communication frequency devices, and the communication functional data 82 is acquired. The procedure of this process is as described in FIG. 8. It should be noted that this process may be performed on a regular basis regardless of detection results of a high function fax server, as the processes in Steps #15 and #16, for example, and that the newest communication functional data 82 may be used for processes in Step #23 and thereafter.

A process is performed (#23) in which it is judged whether or not to shift the role of the fax server of the segment SG1 from the image forming device 1A to the image forming device 1B. Herein, it is judged whether or not the image forming device 3 that can be a correspondent in SIP-based fax communications is present in the other segments SG, and if the image forming device 3 is present, then it is judged that shifting is to be performed because it is advantageous to perform shifting to the image forming device 1B. Details of this process are as described in FIG. 9.

If it is judged that shifting is to be performed for the image forming device 1B (#24: Yes), then shifting is recommended (#25) by transmitting the screen data 85 for displaying the server shift recommendation screen HG1 to an e-mail address of the administrator.

Subsequently, if a command to perform shifting is received from the administrator (#26: Yes), then a process is started (#27) for shifting the role of the fax server from the image forming device 1A to the image forming device 1B. Details of this process are as described in FIG. 11.

It is preferable that the portions shown in FIG. 3 be provided also in the image forming device 1B, as in the image forming device 1A. Alternatively, it is always possible to implement the portions shown in FIG. 3 by installing a program on the hard disk of the image forming device 1B. Then, after taking over the role of the fax server of the segment SG1, the image forming device 1B performs processes in FIG. 14, as the image forming device 1A. More specifically, if a high function fax server is detected and it is judged that it is better to shift the role of the fax server to the high function fax server, then the server shift process is performed.

According to this embodiment, it is possible to let a device having a high communication function and a fax server function in the segment SG1 play the role of the fax server in the segment SG1. Accordingly, the performance in fax communications between clients of the segment SG1 and fax devices of the other segments SG is improved, and thus convenience for the user is improved.

If a high function fax server to which the role of the fax server has been shifted is provided with the SIP-fax function, then the previous fax server, that is, the image forming device 1A, automatically creates the address book database DBS that supports Session Initiation Protocol (SIP)-fax, and provides it to the high function fax server. Accordingly, it is possible to easily deal with even one-touch buttons used by the user for selecting the transmission destination of fax data at a client.

In this embodiment, when a high function fax server is detected, the image forming device 1A judges whether or not to shift the role of the fax server to the high function fax server, by judging whether or not fax communications with the image forming devices 3 belonging to the intranet ITN are improved. However, it is also possible to make a judgment by judging whether or not fax communications with fax devices outside the intranet ITN are improved.

In this embodiment, a description was made taking as an example a case in which the image forming devices 2 of the MFP are used as clients of the image forming device 1A. However, it is also possible to use a personal computer or a workstation, for example.

In addition, it is possible to change as appropriate the configuration of all or a part of the portions, the processing details, the order of processing, the configuration of databases and others of the intranet ITN, the segments SG, the image forming device 1A, and the SIP server 4 in accordance with the gist of the present invention.

The present invention can make it easy to let a device having a higher communication function in a network such as a LAN play a role of a fax server in the network.

While example embodiments of the present invention have been shown and described, it will be understood that the present invention is not limited thereto, and that various changes and modifications may be made by those skilled in the art without departing from the scope of the invention as set forth in the appended claims and their equivalents.

What is claimed is:

1. A fax server having a function to provide a service of fax communications based on a request from a client, comprising:
a detection portion for detecting a second fax server having a higher communication function than the fax server and having a function to provide the service;
a shift appropriateness judgment portion for judging whether it is necessary to shift a role to provide the service to the client from the fax server to the second fax server detected by the detection portion; and
a shift processing portion for performing a shift process for shifting the role from the fax server to the second fax server if the shift appropriateness judgment portion judges that shifting is to be performed.

2. The fax server according to claim 1,
wherein in a case where the detection portion detects a Session Initiation Protocol (SIP)-fax function as the communication function, if any correspondent device that can be a correspondent device in fax communications has a Session Initiation Protocol (SIP)-fax function, then the shift appropriateness judgment portion judges that the role is to be shifted.

3. The fax server according to claim 2, further comprising:
a fax number data storage portion for storing fax number data indicating a fax number for each correspondent device,
wherein the shift processing portion performs the shift process by creating second telephone number data indicating an Internet Protocol (IP) address or a fax number of the correspondent device having the SIP-fax function based on the fax number data, and transmitting the second telephone number data to the second fax server.

4. The fax server according to claim 3,
wherein the shift processing portion acquires the IP address or the fax number by making an inquiry to a Session Initiation Protocol (SIP) server.

5. The fax server according to claim 1, further comprising:
a selection portion for selecting a communication correspondent device of the fax server, and
an acquisition portion for acquiring communication functional information with respect to a communication function of the communication correspondent device selected by the selection portion,
wherein the shift appropriateness judgment portion judges whether it is necessary to perform shifting to the second fax server, based on the communication functional information acquired by the acquisition portion.

6. The fax server according to claim 5,
wherein the selection portion selects the communication correspondent device based on communication frequency.

7. The fax server according to claim 5,
wherein the shift appropriateness judgment portion judges whether it is necessary to perform shifting to the second fax server, based on a functional difference between the fax server and the second fax server, and the communication functional information acquired by the acquisition portion.

8. A method for managing fax servers in a network within a limited range, comprising:
providing the network with a first fax device having a function to provide a service of fax communications based on a request from a client of the network, and providing the first fax device with a role, as a fax server in the network, to provide the service to the client;
detecting a second fax device having a higher communication function than the first fax device and having a function to provide the service;
judging whether it is necessary to shift the role from the first fax device to the detected second fax device; and
shifting the role from the first fax device to the second fax device, if it is judged that shifting is to be performed.

9. The method for managing fax servers according to claim 8,
wherein in a case where a Session Initiation Protocol (SIP)-fax function is detected as the communication function, if any correspondent device that can be a correspondent device in fax communications has a Session Initiation Protocol (SIP)-fax function, then it is judged that the role is to be shifted.

10. The method for managing fax servers according to claim 8, further comprising:
selecting a communication correspondent device of the first fax device,
acquiring communication functional information with respect to a communication function of the selected communication correspondent device, and
judging whether it is necessary to perform shifting to the second fax device, based on the acquired communication functional information.

11. The method for managing fax servers according to claim 10,
wherein the communication correspondent device is selected based on communication frequency.

12. The method for managing fax servers according to claim 10,
wherein it is judged whether it is necessary to perform shifting to the second fax device, based on a functional difference between the first fax device and the second fax device, and the acquired communication functional information.

13. A computer program product embodied in a computer readable medium for a fax server having a function to provide a service of fax communications based on a request from a client, the computer program product letting the fax server execute:
a first process for detecting a second fax server having a higher communication function than the fax server and having a function to provide the service;
a second process for judging whether it is necessary to shift a role to provide the service to the client from the fax server to the detected second fax server; and
a third process for shifting the role from the fax server to the second fax server, if it is judged that shifting is to be performed.

14. The computer program product according to claim 13,
wherein in a case where a Session Initiation Protocol (SIP)-fax function is detected as the communication function, if any correspondent device that can be a correspondent device in fax communications has a Session Initiation Protocol (SIP)-fax function, then in the second process, the fax server is led to judge that the role is to be shifted.

15. The computer program product according to claim 13, letting the fax server further execute:
a fourth process for selecting a communication correspondent device of the fax server, and
a fifth process for acquiring communication functional information with respect to a communication function of the selected communication correspondent device,
wherein in the second process, the fax server is led to judge whether it is necessary to perform shifting to the second fax server, based on the acquired communication functional information.

16. The computer program product according to claim 15,
wherein in the fourth process, the fax server is led to select the communication correspondent device based on communication frequency.

17. The computer program product according to claim 15,
wherein in the second process, the fax server is led to judge whether it is necessary to perform shifting to the second fax server, based on a functional difference between the fax server and the second fax server, and the acquired communication functional information.
